(19) United States
(12) Patent Application Publication
(10) Pub. No.: US 2008/0201023 A1
(43) Pub. Date: Aug. 21, 2008

(54) Method for reducing quiescent power draw and machine using same

(76) Inventor: Darrel Berglund, Peoria, IL (US)

Correspondence Address: CATERPILLAR c/o LIELL, MCNEIL & HARPER, P.O. BOX 2417, 511 SOUTH MADISON STREET, BLOOMINGTON, IN, 47402-2417, US

(21) Appl. No.: 11/708,288

(22) Filed: Feb. 20, 2007

(51) Int. Cl. G05D 1/00; G05B 19/18

(52) U.S. Cl. 701/1; 700/3

(57) ABSTRACT

A machine includes a master electronic control module and at least one secondary electronic control module. A method of operating the machine includes steps of determining whether preconditions are satisfied for changing the master electronic control module from an operating state to a low power state, and determining whether preconditions are satisfied for changing the secondary electronic control module from an operating state to a power off state. The method also includes steps of changing the secondary electronic control module from the operating state to the power off state, and changing the master electronic control module from the operating state to the low power state.

### TECHNICAL FIELD

The present disclosure relates generally to reducing quiescent power draw, and more particularly to a method for reducing quiescent power draw in machines having at least two electronic control modules.

### BACKGROUND

An electronic control module is well known in the industry for collecting and processing data relevant, and often critical, to proper machine operation. Such data may include, for example, engine speed, fuel/air mixture, temperature, and various other parameters. The data, after collected and processed, can be used to evaluate the performance of the machine and, more specifically, the engine.

More recently, with the implementation of emission control requirements, electronic control modules are commonly used to facilitate more efficient operation of the engine by affecting control decisions based on the data it has collected and processed. These sophisticated electronic control modules consist of central processing units and assorted inputs and outputs dedicated to controlling various components within the engine subsystem of a machine.

The desire to provide such precise control to various other subsystems of a machine has led to the implementation of multiple electronic control modules. For example, it may be desirable to utilize an electronic control module to control the engine of the machine and another electronic control module to control the drive system of the machine. The central processing unit of each electronic control module may be provided with software that is specific to the tasks carried out by each electronic control module. The multiple electronic control modules may be interconnected via a communications line, such as, for example, a database to utilize information from, or pass information to, the various subsystems. In addition, a electronic control module may be provided to control the functions and interactions of the various other electronic control modules.

Although there is a great benefit to utilizing more than one electronic control module, multiple electronic control modules cause a significant power draw on the machine. When the engine is off and the battery is not being continuously charged, the quiescent power draw from each electronic control module may range from about 10 to 15 milliamps. In machines utilizing multiple electronic control modules, this quiescent power draw becomes significant. If the engine has not been started for a period of time, and therefore the battery recharged, the power draw may deplete the battery and an operator may be unable to start the machine.

U.S. Pat. No. 6,198,995 teaches a monitoring system for a vehicle, wherein the vehicle has been placed in a sleep mode. Specifically, the monitoring system scans the various subsystems at a predetermined time interval for wake-up signals and when no wake-signals are detected the time interval between scans is increased. This results in a decreased power draw from the monitoring system when the vehicle is placed in a sleep mode. This reference does not, however, contemplate decreasing the quiescent power draw from the various subsystems of the vehicle.

The present disclosure is directed to one or more of the problems set forth

### SUMMARY OF THE INVENTION

In one aspect, a method of operating a machine having a master electronic control module and at least one secondary electronic control module includes steps of determining whether preconditions are satisfied for changing the master electronic control module from an operating state to a low power state, and determining whether preconditions are satisfied for changing the secondary electronic control module from an operating state to a power off state. The method also includes steps of changing the secondary electronic control module from the operating state to the power off state, and changing the master electronic control module from the operating state to the low power state.

In another aspect, a machine having a ground-engaging element includes a master electronic control module and a secondary electronic control module. At least one of the master electronic control module and the secondary electronic control module is configured to determine whether preconditions are satisfied for changing the master electronic control module from an operating state to a low power state, and determine whether preconditions are satisfied for changing a secondary electronic control module from an operating state to a power off state. At least one of the master electronic control module and the secondary electronic control module is also configured to change the secondary electronic control module from the operating state to the power off state, and change the master electronic control module from the operating state to the low power state.

In still another aspect, a machine having a ground-engaging element includes a plurality of electronic control modules. The plurality of electronic control modules includes at least an electronic control module for controlling an engine of the machine and an electronic control module for controlling an operator interface of the machine. One of the plurality of electronic control modules is designated a master electronic control module and at least one other of the plurality of electronic control modules is designated a secondary electronic control module. At least one of the master electronic control module and the secondary electronic control module is configured to determine whether preconditions are satisfied for changing the master electronic control module from an operating state to a low power state, determine whether preconditions are satisfied for changing a secondary electronic control module from an operating state to a power off state, change the secondary electronic control module from the operating state to the power off state, and change the master electronic control module from the operating state to the low power state.

### BRIEF DESCRIPTION OF THE DRAWINGS

FIG. 1 is a side diagrammatic view of a machine having a control system according to the present disclosure;

FIG. 2 is a block diagram of one embodiment of the control system of FIG. 1;

FIG. 3 is a block diagram of a further embodiment of the control system of FIG. 1 having software installed thereon; and

FIG. 4 is a flow chart of one embodiment of a method of reducing quiescent power draw in a machine having at least two electronic control modules according to the present disclosure.

### DETAILED DESCRIPTION

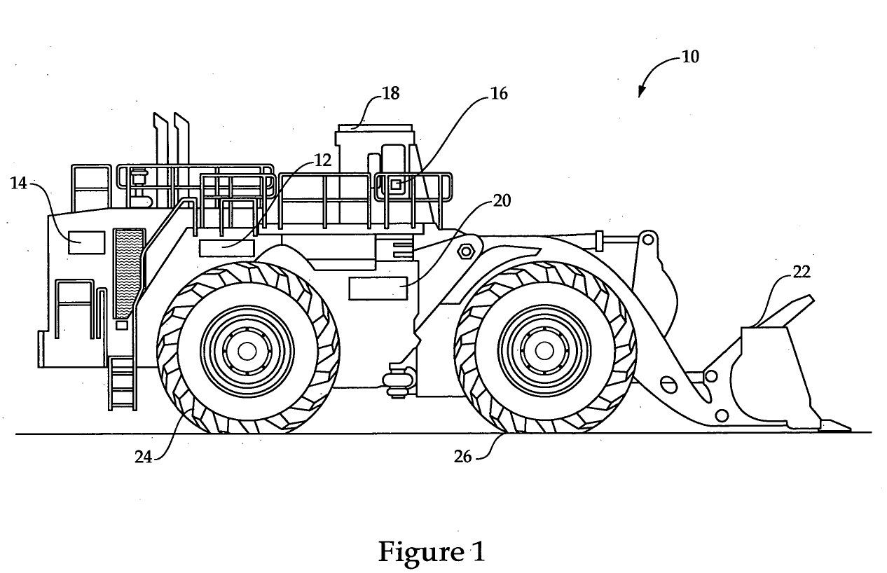

An exemplary embodiment of a machine 10 is shown generally in FIG. 1. The machine 10 may be, for example, a wheel loader, or any other vehicle that utilizes a control system including at least two electronic control modules (ECMs). In the illustrated embodiment, wheel loader 10 includes a control system 12 that comprises at least two ECMs. One ECM may, for example, control an engine 14 and an additional ECM may, for example, control an operator interface 16 located within an operator control station 18. An ECM may also be provided for controlling a drivetrain system 20 of the wheel loader 10 or a work implement of the wheel loader, such as, for example, a bucket 22. In addition, an ECM may be provided for controlling all of the other ECMs utilized by the wheel loader 10. One skilled in the art will appreciate that the control system 12 may include any number of ECMs for controlling any component or subsystem of the wheel loader 10. The wheel loader 10 also includes one or more ground-engaging elements, such as, for example, wheels 24 and 26, and bucket 22. Other examples of ground-engaging elements may include tracks, blades, work implements, or other work processing or propulsion devices.

Each ECM is of standard design and generally includes a processor, such as, for example, a central processing unit, a memory, and an input/output circuit that facilitates communication internal and external to the ECM. The central processing unit controls operation of the ECM by executing operating instructions, such as, for example, programming code stored in memory, wherein operations may be initiated internally or externally to the ECM. A control scheme may be utilized that monitors outputs of systems or devices, such as, for example, sensors, actuators, or control units, via the input/output circuit to control inputs to various other systems or devices.

The memory may comprise temporary storage areas, such as, for example, cache, virtual memory, or random access memory, or permanent storage areas, such as, for example, read-only memory, removable drives, network/internet storage, hard drives, flash memory, memory sticks, or any other known volatile or non-volatile data storage devices located internally or externally to the ECM. One skilled in the art will appreciate that any computer-based system utilizing similar components is suitable for use with the present disclosure.

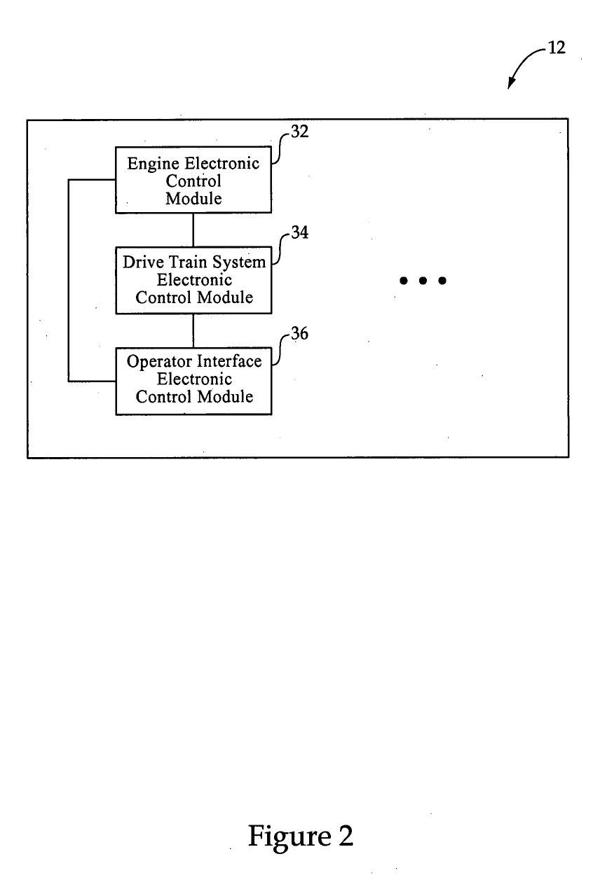

A block diagram of one embodiment of control system 12 is shown generally in FIG. 2. The control system 12 may include an engine ECM 32, a drivetrain system ECM 34, and an operator interface ECM 36. The engine ECM 32 may control various engine components, such as, for example, fuel injectors, and valves, in response to various input signals, such as, for example, engine speed, engine temperature, and various other sensor inputs. The drivetrain system ECM 34 may control various drivetrain components, such as, for example, a transmission, driveshafts, differentials and/or hydraulic or electric motors, and drive wheels, in response to various input signals, such as, for example, transmission position, engine speed, and various other sensor inputs. The operator interface ECM 36 may control various operator interface components, such as, for example, any component or subsystem of the wheel loader 10 that may be controlled by an operator from the operator control station 18, in response to various input signals, such as, for example, sensors, actuators, and various other inputs. Each ECM may be in communication with the other ECMs. In addition, one or more of the ECMs may control functions of one or more of the various other ECMs. Alternatively, a separate ECM may be provided for controlling one or more of the other ECMs.

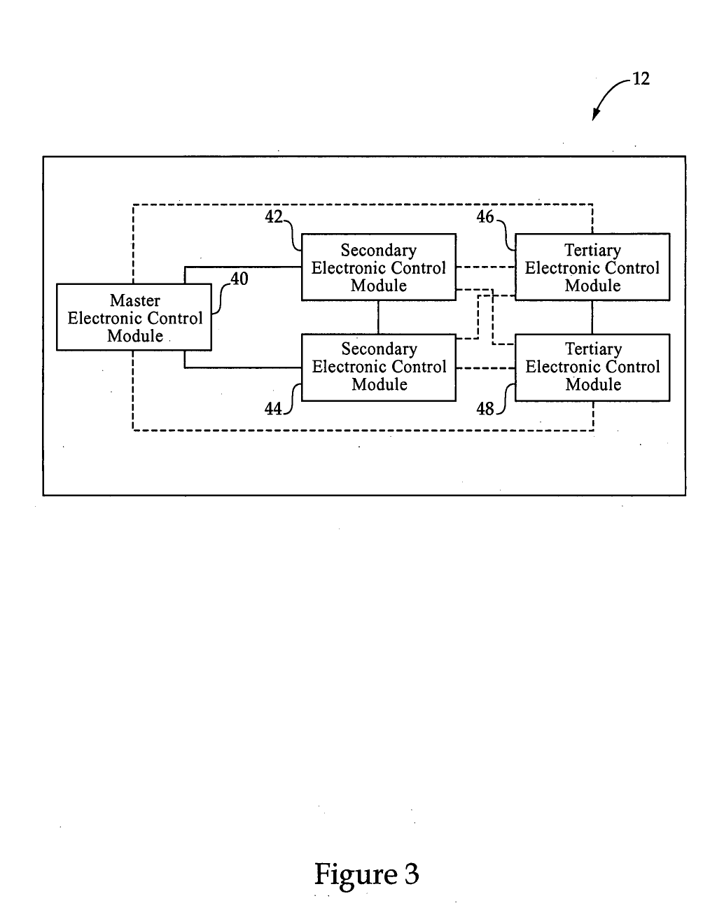

Turning now to FIG. 3, the ECMs of the control system 12 are shown having software installed thereon designating each ECM as a master ECM, a secondary ECM, or, if utilized, a tertiary ECM. The engine ECM 32 may be designated a master ECM 40, while the drivetrain system ECM 34 and the operator interface ECM 36may be designated secondary ECMs 42 and 44. This designation may be arbitrary or, alternatively, may be based on a configuration of, or capabilities of, each ECM. In addition, the control system 12 may include one or more ECMs that are designated tertiary ECMs. For example, an additional ECM, such as, for example, an ECM for controlling the bucket 22, may be designated tertiary ECM 46. In addition, an ECM for controlling one or more of the other ECMs, may be designated tertiary ECM 48.

The master ECM 40 may have software stored in memory that implements a method of reducing power draw of a battery by the control system 12. The secondary ECMs 42 and 44 and tertiary ECMs 46 and 48 may also have software installed thereon for implementing the method of reducing power draw. Alternatively, the secondary ECMs 42 and 44 and tertiary ECMs 46 and 48 may not have software installed thereon, and may take instructions from the master ECM 40. The software installed on each ECM is customized to the tasks to be performed by the ECM based on its designation. The software may be provided on each ECM at a time of manufacture or may be installed on each ECM of the control system 12 anytime thereafter.

ECMs may be designated as secondary or tertiary, or any other suitable classification, as desired. A secondary ECM may receive communication directly from the master ECM, whereas a tertiary ECM may receive communication from the master ECM through another ECM. For example, a tertiary ECM may receive communication from the master ECM via a secondary ECM. A hierarchy of designations may be desired, based on specific tasks performed by or on the various ECMs. One skilled in the art will appreciate that any number of designations or classifications may be made regarding the one or more ECMs for numerous reasons.

### INDUSTRIAL APPLICABILITY

A typical wheel loader 10 utilizes a control system 12 that includes at least two ECMs. While utilizing multiple ECMs provides precise control over the different subsystems of the wheel loader 10, they also cause a significant power draw on the battery of the machine. When the engine is off and the battery is not being continuously charged, the quiescent power draw from each ECM may range from about 10 to 15 milliamps. In machines utilizing multiple ECMs, this quiescent power draw becomes significant. If the engine has not been started for a period of time, and therefore the battery recharged, the power draw may deplete the battery and an operator may be unable to start the machine.

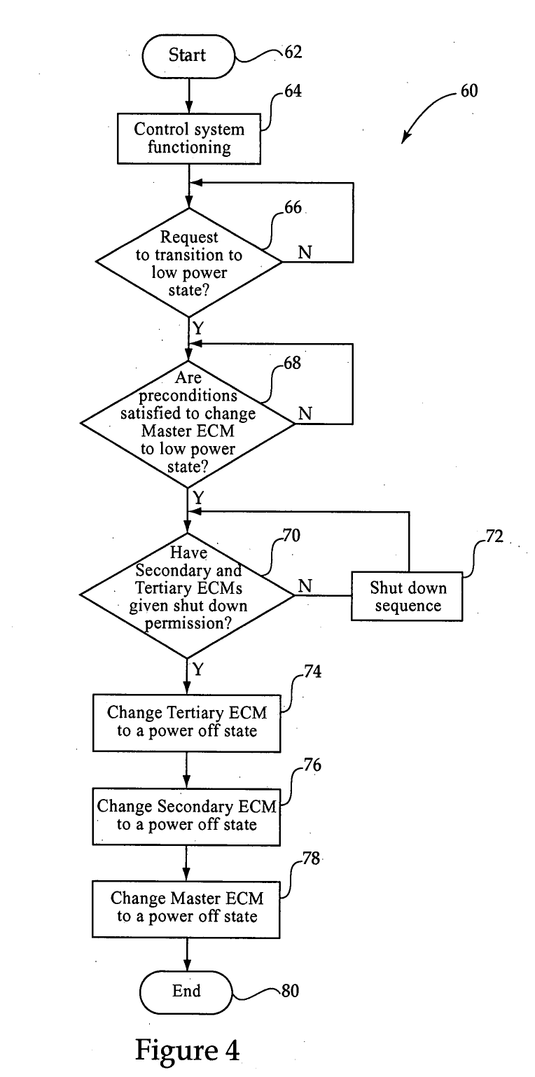

A method of reducing the quiescent power draw of a battery according to FIG. 4 may be implemented to prevent this from occurring. Referring to FIGS. 1-4, flow chart 60 represents an exemplary method of controlling the system 12 of wheel loader 10. The method begins at a START, Box 62. From Box 62, the method may proceed to Box 64, which includes normal functioning of the control system 12. At Box 66, the method determines if a request to transition the control system 12 to a low power state has been received. This request may be initiated by switching an ignition of the wheel loader 10 to an off position or may be initiated at a predetermined period of time after the ignition of the wheel loader has been switched off. If a low power state has been requested, the method continues to Box 68. If a low power state has not been requested, the method waits until such a request is made.

At Box 68, the method or, more specifically, the master ECM 40 determines if preconditions have been satisfied to change the master ECM from an operating state to a low power state. These preconditions may include checking a status of at least one operating condition, such as, for example, a software update, of the master ECM. It is desirable to ensure such a software update has completed before continuing the method. The preconditions may also include ensuring that a monitored condition of the machine 10 is less than a predetermined threshold. Such monitored conditions may include, for example, parking brake activation, temperatures, pressures, and gear speeds. If an ECM is utilized for controlling a hydraulic implement of the machine 10, it may be desirable to make sure the pressure within a hydraulic circuit of the hydraulic implement is below a predetermined level before that ECM is changed to a low power or power off state. If an ECM utilizes an ECM to control a transmission of the machine 10, it may be desirable to make sure gear speeds of the transmission are below a predetermined speed before changing that ECM to a low power or power off state. Similarly, it may be desirable to ensure that monitored speeds and temperatures of or within a component or subsystem that is controlled by an ECM are in a desirable range before continuing with the current method that will transition that ECM to a low power or power off state.

If the preconditions have been met for changing the master ECM 40 to a low power state, the method continues to Box 70. At Box 70 the method or, more specifically the master ECM 40 determines if the secondary ECMs 42 and 44 and the tertiary ECMs 46 and 48 have given a shut down permission based on a request from the master ECM. If the preconditions for changing the master ECM 40 have not been met, the method waits until conditions have been satisfied for changing the master ECM from an operating state to a low power state.

If the master ECM 40 determines, at Box 70, that the secondary ECMs 42 and 44 and the tertiary ECMs 46 and 48 have given the shut down permission, the method proceeds to Box 74. A shut down permission may be given after checking a status of at least one operating condition, such as, for example, a software update, of the secondary and tertiary ECMs. It is desirable to ensure such a software update has completed before continuing the method. A shut down permission may also be given after ensuring a monitored condition of the machine 10 is less than a predetermined threshold. Such monitored conditions may include, for example, temperatures, pressures, and gear speeds, and may include the examples described above. If, however, the secondary ECMs 42 and 44 and the tertiary ECMs 46 and 48 do not give a shut down permission or do not respond, a shut down sequence for the secondary and tertiary ECMs is reinitiated at Box 72.

The shut down sequence at Box 72, initiated and carried out by the master ECM 40, may include waiting a predetermined period of time after a response has not been received before continuing to Box 74 of the method, or may include requesting a shut down permission a predetermined number of times before continuing the method. It may be desirable to log an error in a remote location, in a memory of the master ECM 40, or in a memory of the ECM that has not responded with the shut down permission.

At Box 74, the tertiary ECMs 46 and 48 are changed from their normal operating states to power off states. This may be done by the master ECM 40 instructing the tertiary ECMs 46 and 48 to change to a power off state or may be accomplished by the master ECM removing a power source of the tertiary ECMs. From Box 74, the method proceeds to Box 76, where the secondary ECMs 42 and 44 are changed from their normal operating state to power off states. This may be done by the master ECM 40 instructing the secondary ECMs 42 and 44 to change to a power off state or may be accomplished by the master ECM removing a power source of the secondary ECMs. Alternatively, however, the secondary ECMs 42 and 44 and tertiary ECMs 46 and 48 may shut themselves down. This could be done in response to a request by the master ECM 40, or could be done automatically after a predetermined period of time.

From Box 76, the method proceeds to Box 78, where the master ECM 40 changes from an operating state to a low power state. After the master ECM 40, the secondary ECMs 42 and 44, and the tertiary ECMs 46 and 48 have changed to either low power states or power off states, the method proceeds to the END, Box 80.

Additionally, a sequence or method may provided for changing the master ECM 40, the secondary ECMs 42 and 44, and the tertiary ECMs 46 and 48 back to the operating state. A request to transition the control system 12 to an operating state may be received. As an example, this request may be initiated by switching an ignition of the wheel loader 10 to an on position. The method may then change the master ECM 40 from the low power state back to the operating state, and change the secondary ECMs 42 and 44 and the tertiary ECMs 46 and 48 from the power off state to the operating state.

Although the method of FIG. 4 was described in the context of a wheel loader 10, it should be appreciated that the method may be utilized by any machine or system that includes two or more control modules that draw power from a common source, or even different sources. In addition, those skilled in the art should appreciate that the master ECM 40 may initiate or conduct the sequences or steps of the method of FIG. 4 or, alternatively, one or more of the secondary ECMs 42 and 44 or tertiary ECMs 46 and 48 may be configured to initiate or conduct one or more of the steps. Although the steps of the method are presented in a specific order, those skilled in the art will appreciate that the steps may be performed in alternative sequences without deviating from the spirit of the present disclosure.

It should be understood that the above description is intended for illustrative purposes only, and is not intended to limit the scope of the present invention in any way. Thus, those skilled in the art will appreciate that other aspects of the invention can be obtained from a study of the drawings, the disclosure and the appended claims.

What is claimed is:

1. A method of operating a machine having a master electronic control module and at least one secondary electronic control module, comprising:
determining whether preconditions are satisfied for changing the master electronic control module from an operating state to a low power state;
determining whether preconditions are satisfied for changing the secondary electronic control module from an operating state to a power off state;
changing the secondary electronic control module from the operating state to the power off state; and
changing the master electronic control module from the operating state to the low power state.

2. The method of claim 1, wherein the step of determining whether preconditions are satisfied for changing the master electronic control module from an operating state to a low power state includes checking a status of at least one operating condition of the master electronic control module.

3. The method of claim 2, wherein the step of determining whether preconditions are satisfied for changing the master electronic control module from an operating state to a low power state further includes determining whether a software update of the master electronic control module is complete.

4. The method of claim 2, wherein the step of determining whether preconditions are satisfied for changing the master electronic control module from an operating state to a low power state further includes determining whether a monitored condition of the control system is less than a predetermined threshold.

5. The method of claim 4, wherein the step of determining whether preconditions are satisfied for changing the master electronic control module from an operating state to a low power state further includes at least one of determining whether a temperature is below a predetermined threshold, determining whether a pressure is below a predetermined threshold, and determining whether a gear speed is below a predetermined threshold.

6. The method of claim 1, wherein the step of determining whether preconditions are satisfied for changing the secondary electronic control module from an operating state to a power off state includes checking a status of at least one operating condition of the secondary electronic control module.

7. The method of claim 6, wherein the step of determining whether preconditions are satisfied for changing the secondary electronic control module from an operating state to a power off state further includes determining whether a software update of the secondary electronic control module is complete.

8. The method of claim 6, wherein the step of determining whether preconditions are satisfied for changing the secondary electronic control module from an operating state to a power off state further includes determining whether a monitored condition of the control system is less than a predetermined threshold.

9. The method of claim 8, wherein the step of determining whether preconditions are satisfied for changing the secondary electronic control module from an operating state to a power off state further includes at least one of determining whether a temperature is below a predetermined threshold, determining whether a pressure is below a predetermined threshold, and determining whether a gear speed is below a predetermined threshold.

10. The method of claim 1, wherein the step of changing the secondary electronic control module includes at least one of directing the secondary electronic control module to change to a power off state and disabling a power source of the secondary electronic control module.

11. The method of claim 1, further including:
requesting a power off permission from the secondary electronic control module; and
changing the secondary electronic control module from the operating state to the power off state in response to at least one of a receipt of the power off permission and a lapse of a predetermined period of time.

12. The method of claim 1, further including:
receiving a request to transition the machine to a power on state;
returning the master electronic control module to the operating state; and
returning the secondary electronic control module to the operating state.

13. A machine having a ground-engaging element, comprising:
a master electronic control module and a secondary electronic control module, wherein at least one of the master electronic control module and the secondary electronic control module is configured to determine whether preconditions are satisfied for changing the master electronic control module from an operating state to a low power state, configured to determine whether preconditions are satisfied for changing a secondary electronic control module from an operating state to a power off state, configured to change the secondary electronic control module from the operating state to the power off state, and configured to change the master electronic control module from the operating state to the low power state.

14. The machine of claim 13, wherein the master electronic control module is further configured to request a power off permission from the secondary electronic control module, and change the secondary electronic control module from the operating state to the power off state in response to at least one of a receipt of the power off permission and a lapse of a predetermined period of time.

15. The machine of claim 13, wherein the machine includes a drive train system and at least one work implement.

16. The machine of claim 15, wherein the machine includes an electronic control module for controlling an engine of the machine and an electronic control module for controlling an operator interface of the machine.

17. The machine of claim 15, wherein the master electronic control module is further configured to receive a request to transition the machine to a power on state, return the master electronic control module to the operating state, and return the secondary electronic control module to the operating state.

18. The machine of claim 15, wherein at least one other electronic control module is designated a tertiary electronic control module.

19. The machine of claim 18, wherein at least one of the master electronic control module, the secondary electronic control module, and the tertiary electronic control module is further configured to determine whether preconditions are satisfied for changing the tertiary electronic control module from an operating state to a power off state, and change the tertiary electronic control module from the operating state to the power off state.

20. A machine having a ground engaging element, comprising:
a plurality of electronic control modules, wherein the plurality of electronic control modules includes at least an electronic control module for controlling an engine of the machine and an electronic control module for controlling an operator interface of the machine;
wherein one of the plurality of electronic control modules is designated a master electronic control module and at least one other of the plurality of electronic control modules is designated a secondary electronic control module; and
wherein at least one of the master electronic control module and the secondary electronic control module is configured to determine whether preconditions are satisfied for changing the master electronic control module from an operating state to a low power state, configured to determine whether preconditions are satisfied for changing a secondary electronic control module from an operating state to a power off state, configured to change the secondary electronic control module from the operating state to the power off state, and configured to change the master electronic control module from the operating state to the low power state.
